(19) United States
(12) Patent Application Publication
(10) Pub. No.: US 2015/0367498 A1
(43) Pub. Date: Dec. 24, 2015

(54) MULTI-FUNCTION TOOL WITH FIXING FUNCTION

(71) Applicant: RE-DAI Precision Tools Co., Ltd., Taichung City (TW)

(72) Inventor: YI CHIU CHOU, Taichung City (TW)

(21) Appl. No.: 14/556,277

(22) Filed: Dec. 1, 2014

(30) Foreign Application Priority Data
Jun. 19, 2014 (TW) 103210850

(51) Int. Cl. B25G 1/06; B25B 23/00; B25B 13/46

(52) U.S. Cl. CPC B25G 1/063; B25B 13/461; B25B 23/0007

(57) ABSTRACT

A multi-function tool with a fixing function comprises a handle body having a receiving slot; a ratchet handle being a combination of a rod body and a work head, the rod body being pivotally mounted on the receiving slot, and a surface of one end of the rod body having a toothed portion; a mounting, hole formed on an end portion of the handle body and abutting upon the receiving slot; a ball hole formed on a bottom surface of the mounting hole and communicating with the receiving slot; and a positioning assembly constituted by a push block, a spring and a steel ball, the push block surface having a positioning cavity and a release cavity, the push block being connected to the spring and disposed in the mounting hole, the steel ball being disposed in the ball hole. The push block is moved so that the steel ball meshes with the toothed portion of the rod body and the positioning cavity, and the ratchet handle is positioned. The push block is moved so that the steel ball is disposed between the release cavity and the toothed portion, and the ratchet handle can be rotated. Thus, the ratchet handle can change the angle of the handle body and be retracted into the handle body, and the locking mechanism of the positioning assembly can make, the ratchet handle have a stable positioning effect. [ [symbol] 150 [symbol] ]

### BACKGROUND OF THE INVENTION

1. Field of the Invention

The invention relates to the technical field of a hand tool, and more particularly to a multi-function tool capable of switching between retracted and deployed states of the hand tool and of changing the using angle of the hand tool.

2. Related Art

In a typical ratchet wrench, one end of a rod-like handle body has a ratchet mechanism. The user can arrange a sleeve or a connection rod on the ratchet mechanism, and exert an acting force for rotating the handle body to make the sleeve or the connection rod generate a torsional force.

Usually, if the handle body is designed to have a longer length, the laborsaving effect is obtained upon operation. However, the combination of the longer handle body and the ratchet mechanism significantly requires the larger accommodating space and induces the drawback of inconvenience of carrying. On the contrary, if the handle is designed to have the shorter length, then the larger acting force needs to be exerted upon operation, but the overall size is small and the advantage of easy retracting and carrying is obtained.

Therefore, designing the hand tool to be foldable or retractable is a method of solving the problem caused by the longer hand tool. For example, each of Taiwan Patent Nos. M449068 and M409142 disclosed a hand tool, which can be retracted when not being used so as to decrease the size and facilitate the retraction. The hand tool can be deployed to provide the larger torque effect when being used.

In addition, Taiwan Patent No. M449068 further disclosed a locking mechanism provided by a combination of a spring and a steel ball. When the work handle of the hand tool and the handle are in the retracted or deployed state, the combination of the spring and the steel ball can lock the tool handle. However, the steel ball rests against one end of the spring, so the steel ball tends to be forced to produce the displacement, so that the tool handle produces the unpredictable movement.

### SUMMARY OF THE INVENTION

The invention is to provide a multi-function tool with a fixing function, wherein the multi-function tool can change the length and driving angle of the hand tool according to the using requirement to satisfy the requirements of different using environments and different acting forces.

The invention is to provide a multi-function tool with a fixing function, wherein the stable positioning effect can be obtained when the hand tool is in either the retracted or deployed state.

To achieve the above-identified objects, the invention provides a tool structure including a handle body; a receiving slot being a longitudinal slot formed in the handle body; a ratchet handle comprising a rod body and a work head, wherein a surface of one end of the rod body has a toothed portion, the other end of the rod body is combined with the work head, and the rod body is pivotally mounted on the receiving slot; a mounting hole formed on an end portion of the handle body and abutting upon an end portion of the receiving slot; a ball hole, which is formed on a bottom surface of the mounting hole and is communicated with the receiving slot; and a positioning assembly comprising a push block, a spring and a steel ball. A surface of the push block has a positioning cavity and a release cavity. The push block and the spring are disposed in the mounting hole. One end of the spring rests against an end wall surface of the mounting hole. The other end of the spring rests against an end surface of the push block, and the steel ball is disposed in the ball hole. The push block is moved so that the steel ball meshes with the toothed portion of the rod body and the positioning cavity, and the ratchet handle is positioned; and the push block is moved so that the steel ball is disposed between the release cavity and the toothed portion, and the ratchet handle can be rotated close to or away from the receiving slot.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a pictorial view of the invention.

FIG. 2 shows an exploded view of the invention.

FIG. 3 shows an exploded view of the invention in another direction.

FIG. 4 shows a schematic view of an assembled structure of a handle body and a ratchet handle of the invention.

FIG. 5 shows a schematic view of a retracted and locked structure of the ratchet handle of the invention.

FIG. 6 shows a schematic view of a retracted and released structure of the ratchet handle of the invention.

### DETAILED DESCRIPTION OF THE INVENTION

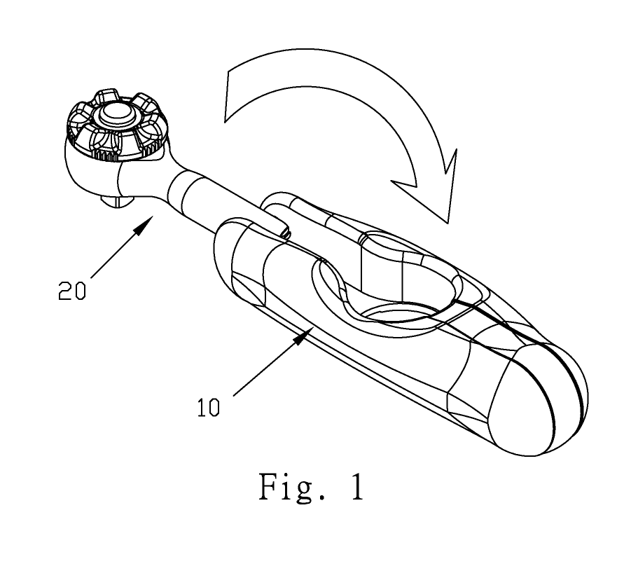

Referring to FIG. 1, the invention comprises a handle body 10 and a ratchet handle 20 combined with the handle body 10. More particularly, an included angle between the ratchet handle 20 and the handle body 10 may be formed, or the ratchet handle 20 may further be retracted and accommodated into the handle body 10.

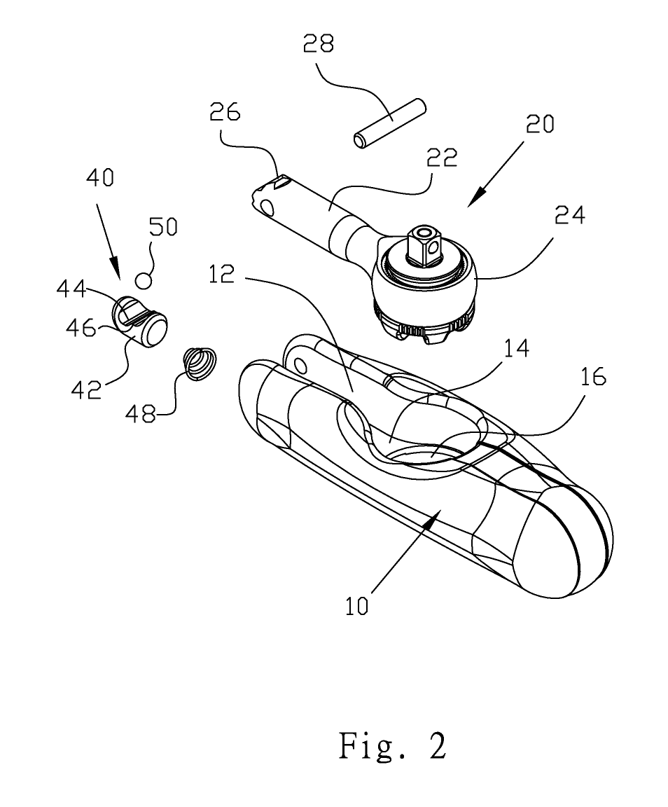

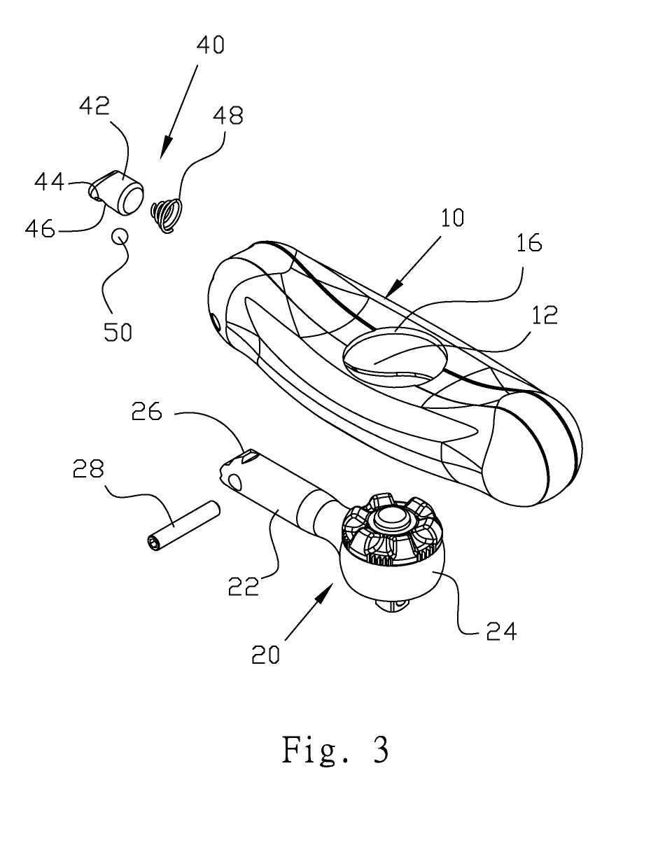

Referring to FIGS. 2 and 3, a receiving slot 12 is a longitudinal slot formed in the handle body 10. One side of the receiving slot 12 has an open structure. Also, the other side of the receiving slot 12 is a slot bottom 14, and the slot bottom 14 has a penetrating through hole 16.

The ratchet handle 20 comprises a rod body 22 and a work head 24. Furthermore, a surface of one end of the rod body 22 has a toothed portion 26, and the other end of the rod body 22 is combined with the work head 24. In addition, the rod body 22 is pivotally mounted on the receiving slot 12 in conjunction with a pin 28.

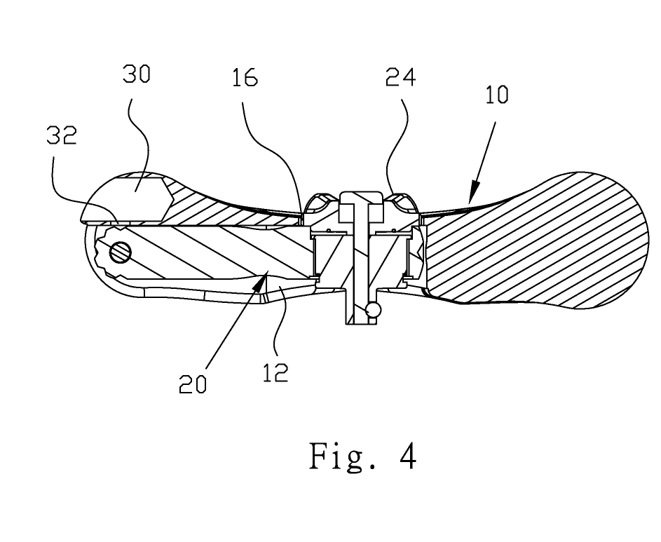

Referring to FIG. 4, the ratchet handle 20 may be rotated and accommodated into the receiving slot 12 of the handle body 10, and the work head 24 is embedded into the through hole 16. A mounting hole 30 is formed on the end portion of the handle body 10, and the mounting hole 30 abuts upon the end portion of the receiving slot 12. Also, a ball hole 32 is formed on the bottom surface of the mounting hole 30, and the ball hole 32 is communicated with the receiving slot 12.

Referring again to FIGS. 2 and 3, the invention further comprises a positioning assembly 40 to be mounted on one end of the handle body 10. Furthermore, the positioning assembly 40 comprises a push block 42, a spring 48 and a steel ball 50. The surface of the push block 42 is formed with a release cavity 44 and a positioning cavity 46. The positioning cavity 46 is connected to the release cavity 44, and the aperture (radius of curvature) of the release cavity 44 is larger than the aperture (radius of curvature) of the positioning cavity 46.

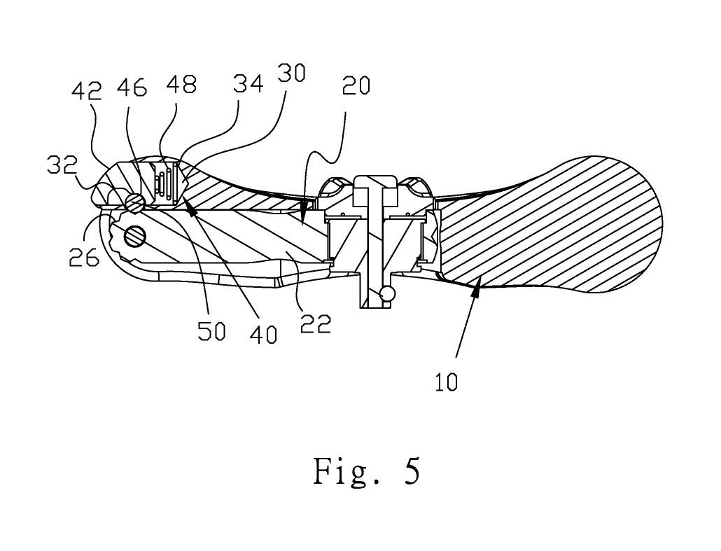

Referring to FIG. 5, the positioning assembly 40 is mounted in the mounting hole 30. Furthermore, the push block 42 and the spring 48 are disposed in the mounting hole 30. More particularly, one end of the spring 48 rests against an end wall surface 34 of the mounting hole 30, and the other end of the spring 48 rests against the end surface of the push block 42. Next, the steel ball 50 is disposed in the ball hole 32, and the steel ball 50 is correspondingly located at the toothed portion 26 on one end of the rod body 22.

Referring again to FIG. 5, the steel ball 50 meshes with the toothed portion 26 and the positioning cavity 46, so the ratchet handle 20 can be locked and cannot be rotated. In the drawing, although the retracted state where the ratchet handle 20 is disposed in the handle body 10 is not shown, the ratchet handle 20 itself forms the locked state once the steel ball 50 meshes with the toothed portion 26 and the positioning cavity 46 even if the ratchet handle 20 and the handle body 10 form an angled deployed state. Thus, the design of the invention can make the ratchet handle 20 have the stable positioning effect.

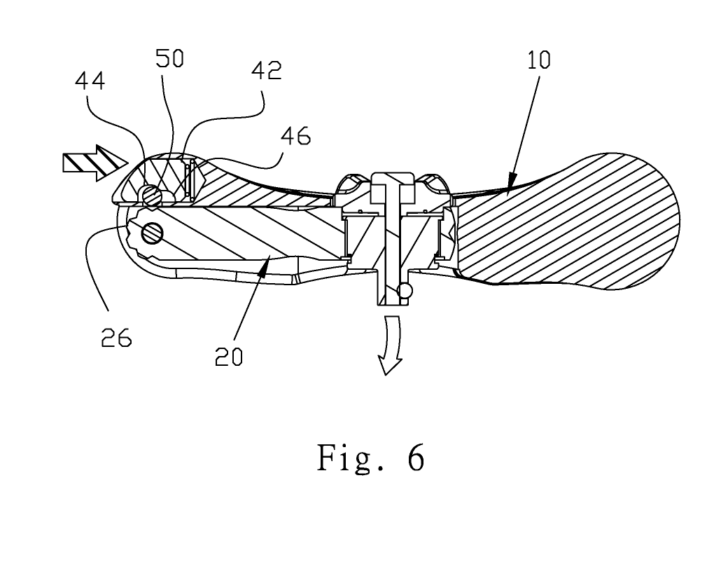

Referring to FIG. 6, the user can press (push) the push block 42 so that the steel ball 50 corresponds to the release cavity 44. More particularly, the steel ball 50 is disposed between the release cavity 44 and the toothed portion 26, and the steel ball 50 does no mesh with the toothed portion 26. Consequently, the ratchet handle 20 can be rotated and moved out (rotated out) of the handle body 10, or moved toward the handle body 10. Thereafter, the acting force exerted on the push block 42 is released, so that the steel ball 50 meshes with the positioning cavity 46 and the toothed portion 26.

Therefore, the invention can change the length and driving angle of the hand tool according to the requirement to satisfy the requirements of different environments and different acting forces. In addition, the hand tool can have the stable positioning effect in either the retracted state or the deployed state.

What is claimed is:

1. A multi-function tool, which has a fixing function and is capable of changing a using condition and a using angle, the multi-function tool comprising:
a handle body;
a receiving slot being a longitudinal slot formed in the handle body, wherein one side of the receiving slot has an open structure;
a ratchet handle comprising a rod body and a work head, wherein a surface of one end of the rod body has a toothed portion, the other end of the rod body is combined with the work head, and the rod body is pivotally mounted on the receiving slot;
a mounting hole formed on an end portion of the handle body and abutting upon an end portion of the receiving slot;
a ball hole, which is formed on a bottom surface of the mounting hole and is communicated with the receiving slot; and
a positioning assembly comprising a push block, a spring and a steel ball, wherein a surface of the push block has a positioning cavity and a release cavity, the push block and the spring are disposed in the mounting hole, one end of the spring rests against an end wall surface of the mounting hole, the other end of the spring rests against an end surface of the push block, and the steel ball is disposed in the ball hole;
wherein the push block is moved so that the steel ball meshes with the toothed portion of the rod body and the positioning cavity, and the ratchet handle is positioned; and the push block is moved so that the steel ball is disposed between the release cavity and the toothed portion, and the ratchet handle can be rotated close to or away from the receiving slot.

2. The multi-function tool according to claim 1, wherein the positioning cavity is connected to the release cavity, and an aperture of the release cavity is larger than an aperture of the positioning cavity.

3. The multi-function tool according to claim 1, wherein the other side of the receiving slot has a slot bottom, the slot bottom has a penetrating through hole, and when the ratchet handle is retracted into the receiving slot, the work head is embedded into the through hole.
